(19) United States
(12) Patent Application Publication
(10) Pub. No.: US 2012/0110389 A1
(43) Pub. Date: May 3, 2012

(54) METHOD FOR OBTAINING STORAGE DEVICE STATE SIGNAL BY USING BMC

(75) Inventors: Chih Wei Chen, Taipei (TW); Hsiao Fen Lu, Taipei (TW)

(73) Assignee: INVENTEC CORPORATION, Taipei (TW)

(21) Appl. No.: 13/033,779

(22) Filed: Feb. 24, 2011

(30) Foreign Application Priority Data
Oct. 29, 2010 (TW) 099137323

(51) Int. Cl. G06F 11/30

(52) U.S. Cl. 714/47.1; 714/E11.179

(57) ABSTRACT

A method for obtaining a storage device state signal by using a Baseboard Management Controller (BMC) includes defining a sensor monitored by the BMC, in which the value of the sensor indicates the state of a storage device; converting the storage device state signal generated by a storage device controller into an electric signal by using a hardware coding method; and reading the electric signal and appointing the read value of the electric signal as the value of the sensor.

### CROSS-REFERENCE TO RELATED APPLICATIONS

This non-provisional application claims priority under 35 U.S.C. §119(a) on Patent Application No(s). 099137323 filed in Taiwan, R.O.C. on Oct. 29, 2010, the entire contents of which are hereby incorporated by reference.

### BACKGROUND OF THE INVENTION

1. Field of Invention

The present invention relates to a method for obtaining a storage device state signal, and more particularly to a method for obtaining a storage device state signal by using a Baseboard Management Controller (BMC).

2. Related Art

With the popularity of the computer and the fast development of the network technology, services provided by an ordinary computer or device are inadequate for use, so a server technology is developed. The server is a computer platform adept in handling the network technology, which can be connected to various network systems, and provides various application services through computers connected to the network system. Most of the servers have large-capacity storage device, so as to provide services such as multimedia playing, network hard disks, or databases for enterprises. It can be seen that, the storage device is a rather important component in a server. Once a fault occurs, it will have a bad effect on the server even on the services provided to clients.

In order to manage the server, an Intelligent Platform Management Interface (IPMI) technology emerges. The manager can monitor the server through the IPMI and the Baseboard Management Controller (BMC) configured in the server. However, after a fault occurs in the storage device, the present server sends a state signal and then lightens an indicator on the server through a hardware operating independently, and the storage device state signal is not transmitted to management software through the IPMI. That is to say, the conventional state signal is decoded and controlled directly by hardware, which causes the problem that the conventional server cannot integrate parallel state signal and management mechanisms, and also cannot inform the manager of the fault efficiently.

### SUMMARY OF THE INVENTION

Accordingly, the present invention provides a method for obtaining a storage device state signal by using a Baseboard Management Controller (BMC), which is applicable in a server having the BMC and a storage device. The method comprises: defining a sensor monitored by the BMC, in which the value of the sensor indicates the state of the storage device; converting the storage device state signal generated by a storage device controller into an electric signal by using a hardware coding means; and reading the electric signal and appointing the value of the read electric signal as the value of the sensor.

According to an embodiment, the storage device state signal may be a storage device fault signal to indicate a fault occurring. Besides, the electric signal may be read by an input/output expander (I/O expander).

According to an embodiment, the hardware coding means may be a Complex Programmable Logic Device (CPLD), the electric signal is read by the I/O expander from the CPLD, and the storage device controller may monitor the state of the storage device and transmits the storage device state signal to the CPLD according to the state. The storage device controller may transmit an electric signal to the CPLD through a serial general purpose input/output (SGPIO). The sensor of the BMC may read the electric signal from the I/O expander through an inter-integrated circuit bus (I²C bus).

In addition, the method for obtaining the storage device state signal by using the BMC may further comprise: lightening (driving) a light emitting diode (LED) group corresponding to the storage device by the CPLD, according to the electric signal.

According to an embodiment, the method for obtaining the storage device state signal by using the BMC may also comprise: executing a storage device management program according to the value of the sensor.

The storage device management program may comprise: informing a remote management program connected to the BMC through an Intelligent Platform Management Bus (IPMB). The storage device management program may also comprise: suspending at least one storage unit of the storage device according to the electric signal. The storage device comprises the plurality of storage units, and the electric signal corresponds to the storage units.

In view of the above, after the electric signal is generated through the method for obtaining the storage device state signal by using the BMC, the corresponding LED group is lightened and the lightening is informed to the BMC through the sensor. Therefore, the magnetic disk fault lightening mechanism controlled by the hardware is integrated into the BMC management, so that the management interface is unified to improve the management efficiency.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a schematic view of a server according to an embodiment;

FIG. 2 is a flow chart of a method for obtaining a storage device state signal by using a BMC according to an embodiment;

FIG. 3 is a flow chart of a method for obtaining a storage device state signal by using a BMC according to another embodiment; and

FIG. 4 is a schematic view of a server according to another embodiment.

### DETAILED DESCRIPTION OF THE INVENTION

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

The present invention provides a method for obtaining a storage device state signal by using a Baseboard Management Controller (BMC), which is applied in a server having the BMC and a storage device.

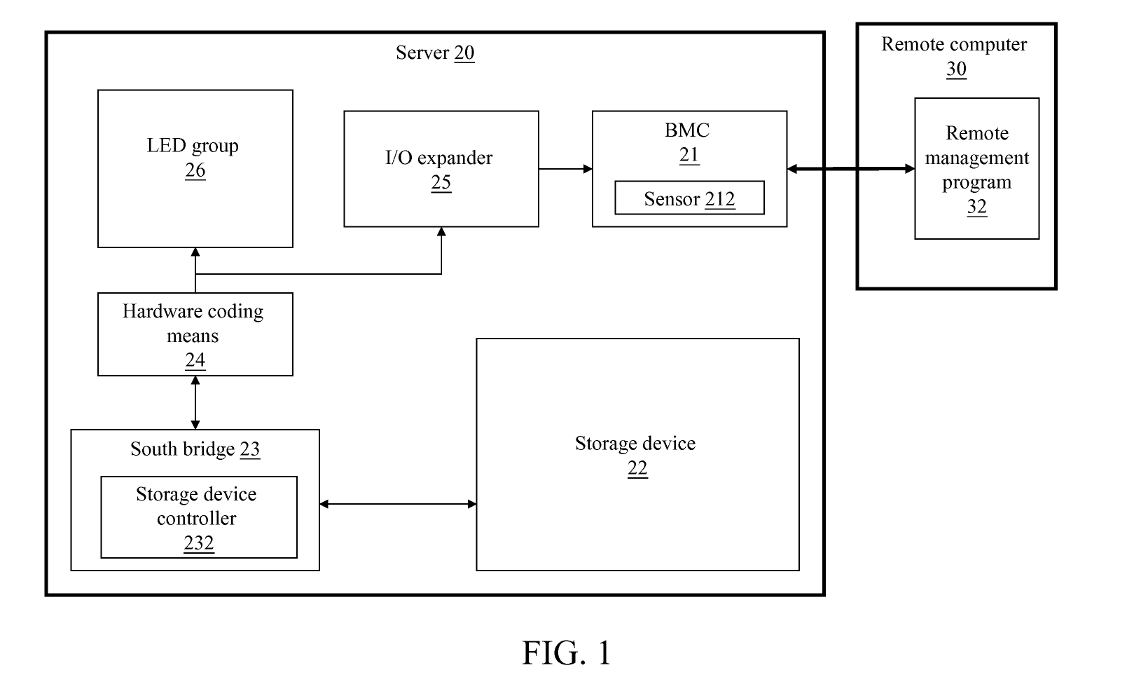

Referring to FIG. 1, a schematic view of a server according to an embodiment is shown. The server 20 comprises the BMC 21, the storage device 22, and a south bridge 23 of a central processing unit (CPU) (not shown in the FIG.), in which the south bridge 23 is electrically connected to the storage device 22 through a storage device controller 232. The storage device 22 may be various high-capacity hard disks, or a redundant array of inexpensive disk (RAID) system. The server 20 is connected to a remote computer 30 through a network, and the remote computer manages the server 20 through a remote management program 32 and the BMC 21.

The server 20 may support the IPMI and execute an operating system through the above hardware. The server 20 may use operating systems such as Linux of Unix, FreeBSD or Windows Server 2003 of Microsoft, or may use a Disk Operating System (DOS) or an Extensible Firmware Interface (EFI) system. The server 20 may be various servers of various brands, and it is not limited in the present invention.

Specifically, the IPMI is a standard architecture of a server management platform, and comprises five components, namely, the BMC 21, a system interface, a non-volatile storage, an intelligent platform management bus (IPMB) and an intelligent chassis management bus (ICMB), in which the most important component is the BMC 21. The BMC 21 is like an independent computer and comprises a processor and a memory thereof. The operation of the BMC 21 uses the resources thereof, and does not occupy other resources of a hardware module of the server 20. For example, the remote computer 30 may use an iLO system of HP company, an iDRAC system of DELL company, or an ESB2 system of Intel company.

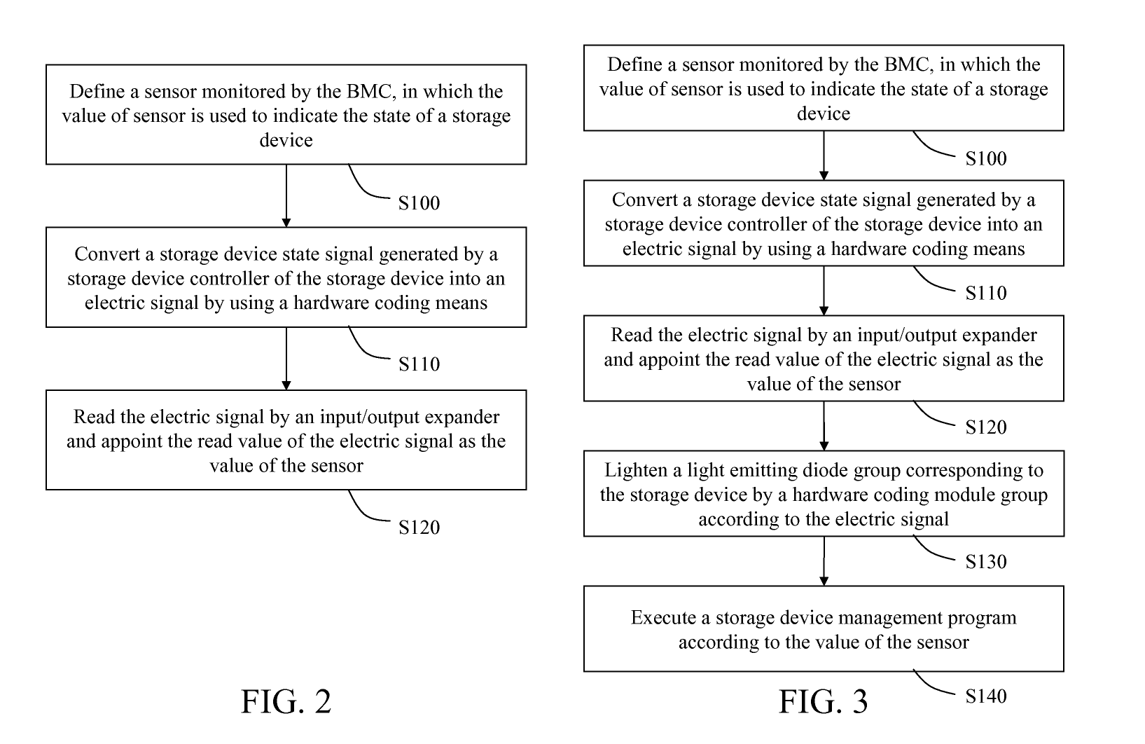

Referring to FIG. 2 in combination with FIG. 1, FIG. 2 is a flow chart of a method for obtaining a storage device state signal by using a BMC according to an embodiment. First, a sensor 212 monitored by the BMC 21 is defined, in which the value of the sensor 212 is used to indicate the state of the storage device 22, for example whether a fault occurs (Step S100). The BMC 21 may comprise a plurality of other sensors to monitor the hardware such as a CPU of the server 20, and the sensor 212 is defined additionally in the Step S100.

The storage device controller 232 monitors the state of the storage device 22 in real time, and the storage device controller 232 generates a storage device state signal and transmits the signal to a hardware coding means 24 of the server 20. When a fault occurs in the storage device 22, the storage device controller 232 may generates a storage device fault signal as the storage device signal and transmits it. In other words, when a fault occurs, the storage device state signal may be the storage device fault signal to indicate the fault occurring. The server 20 converts the storage device state signal transmitted by the storage device controller 232 of the storage device 22 into an electric signal (Step S110).

The hardware coding means 24 may be a Complex Programmable Logic Device (CPLD). The CPLD may comprise a plurality of Programmable Array Logic (PAL), and implements various calculation and combinational logic. The inter-connection line between the PAL may perform a programmed plan and burn. The CPLD uses such All-In-One integration method, so that a circuit composed by thousands of or even hundred thousands of logic gates is implemented. In this embodiment, the CPLD is programmed so as to perform the function required by the hardware coding means 24. For example, the CPLD may receive the storage device state signal transmitted by the storage device controller 232 through a serial general purpose input/output (SGPIO), and the storage device state signal is coded again into an electric signal.

Then, the electric signal may be read by an input/output expander (I/O expander) 25, and the read value of the electric signal is appointed as the value of the sensor (Step S120). That is to say, the I/O expander 25 may read the electric signal through the CPLD, and then the BMC 21 reads the electric signal from the I/O expander. The BMC 21 may be connected to the I/O expander 25 through an inter integrated circuit bus (I²C bus). The sensor 212 regularly reads the electric signal through the I²C bus, and uses the content of the electric signal as the value thereof.

Referring to FIG. 3, a flow chart of a method for obtaining a storage device state signal by using a BMC according to another embodiment is shown. The method for obtaining the storage device state signal by using the BMC may further comprise: lightening (that is, driving) an light emitting diode (LED) group 26 corresponding to the storage device 22 by the hardware coding module 24 (such as the CPLD), according to the electric signal (Step S130).

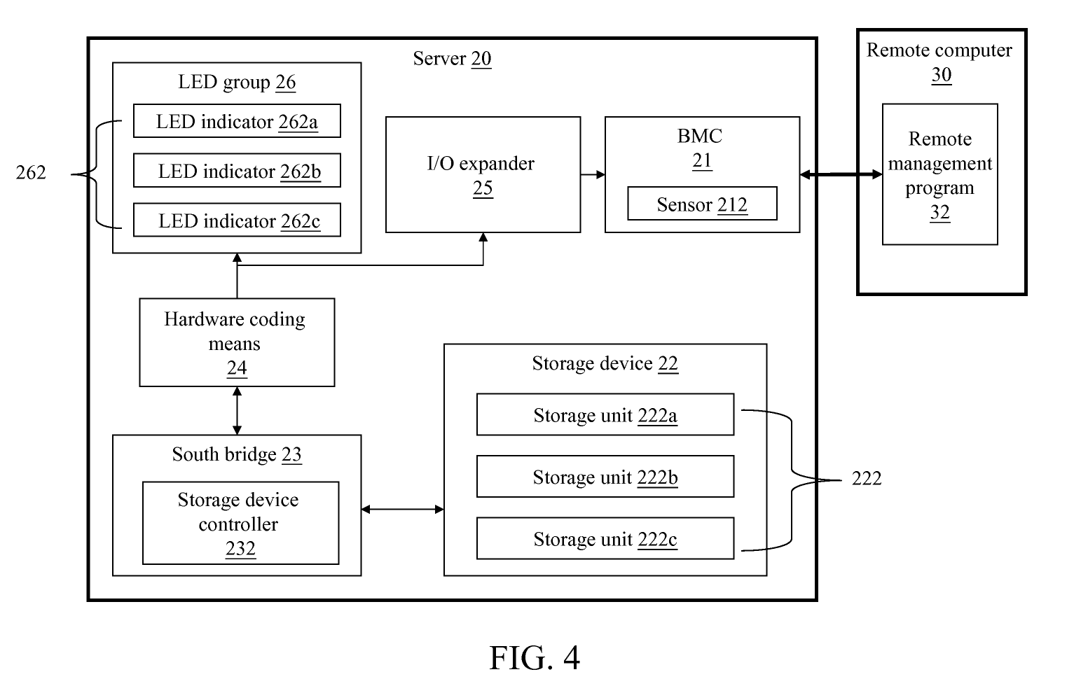

Referring to FIG. 4, a schematic view of a server of another embodiment is shown. The storage device 22 may comprise a plurality of storage units 222, such as the storage unit 222a, the storage unit 222b, and the storage unit 222c. The LED group 26 comprises a plurality of LED indicators 262 which has the same number with the storage units 222, such as the LED indicator 262a, the LED indicator 262b, and the LED indicator 262c. The electric signal coded again corresponds to the storage units 222, and is used to lighten the LED indicators 262. Through the Step S130, the manager of the server 20 can know easily the fault condition of the storage device 22.

The method for obtaining a storage device state signal by using the BMC may comprise: executing the storage device management program according to the value of the sensor 212 (Step S140). The BMC 21 may record the case that a fault occurs in the storage device 22, and perform the subsequent processing according to the storage device management program. The storage device management program may suspend at least one failed storage unit 222 of the storage device 22 according to the electric signal, or inform the remote management program 32 of the remote computer 30 connected to the BMC 21 through the IPMB.

It should be noted that, the performing order of the Step S130 and the Step S140 is not limited.

An embodiment in actual operation according to the method for obtaining the storage device state signal by using the BMC is described in the following.

For example, when a fault occurs in the storage unit 222b, the storage device controller 232 transmits the storage device fault signal as the storage device state signal accordingly. The hardware coding means 24 converts the storage device state signal into the electric signal after receiving the storage device state signal. For example, when a seriary binary code indicates all the storage units 222 correspondingly, and “0” indicates normal state, the electric signal identification “010” indicates that a fault is only in the storage unit 222b now. Then, the hardware coding means 24 transmits the electric signal to the I/O expander 25, and lightens the LED indicator 262b to red according to the electric signal “010.” The LED indicators 262a and 262b corresponding to the storage units 222a and 222b which have no faults may not be lightened, or maintain green to indicate normal state.

The BMC 21 reads the value of the sensor 212 regularly, and it also can be regarded as reading the value of the I/O expander 25 through the sensor 212. The condition that the value of the sensor 212 is all zero indicates that everything is normal. When the BMC 21 receives an electric signal whose value is not zero, the storage device management program is executed to inform the manager through the network and by informing the remote computer 30. In this way, the manager can go to repair or replace the failed storage unit 222b in real time.

In view of the above, in the method for obtaining the storage device fault signal by using the BMC, after the electric signal is generated by using the hardware coding means, the corresponding LED group is not only lightened, but also the lightening is informed to the BMC through the sensor. That is to say, the magnetic disk fault lightening mechanism controlled by the hardware is integrated into the BMC management, so that the management interface is unified. In this way, the problem of the mussy management manner which is like multiple carriages moving in parallel in the conventional art is solved, the server is managed through a more succinct and more efficient method, and the manager is efficiently informed when a fault occurs.

What is claimed is:

1. A method for obtaining a storage device state signal by using a Baseboard Management Controller (BMC), applicable in a server having the BMC and a storage device, the method for obtaining the storage device state signal by using the BMC comprising:
defining a sensor monitored by the BMC, wherein the value of the sensor is used to indicate the state of the storage device;
converting the storage device state signal generated by a storage device controller of the storage device into an electric signal by using a hardware coding means; and
reading the electric signal, and appointing the read value of the electric signal as the value of the sensor.

2. The method for obtaining the storage device state signal by using the BMC according to claim 1, wherein the storage device state signal is a storage device fault signal to indicate a fault occurring.

3. The method for obtaining the storage device state signal by using the BMC according to claim 1, wherein the electric signal is read by an input/output expander (I/O expander).

4. The method for obtaining the storage device state signal by using the BMC according to claim 3, wherein the hardware coding means is a Complex Programmable Logic Device (CPLD), and the I/O expander reads the electric signal through the CPLD.

5. The method for obtaining the storage device state signal by using the BMC according to claim 4, wherein the storage device controller monitors the state of the storage device, and transmits the storage device state signal to the CPLD accordingly.

6. The method for obtaining the storage device state signal by using the BMC according to claim 5, wherein the storage device controller transmits the electric signal to the CPLD through a serial general purpose input/output (SGPIO).

7. The method for obtaining the storage device state signal by using the BMC according to claim 4, further comprising:
lightening a light emitting diode (LED) group corresponding to the storage device by the CPLD according to the electric signal.

8. The method for obtaining the storage device state signal by using the BMC according to claim 3, wherein the sensor of the BMC reads the electric signal from the I/O expander through an inter-integrated circuit bus (I²C bus).

9. The method for obtaining the storage device state signal by using the BMC according to claim 1, further comprising:
executing a storage device management program according to the value of the sensor.

10. The method for obtaining the storage device state signal by using the BMC according to claim 9, wherein the storage device management program comprises:
informing a remote management program connected to the BMC through an Intelligent Platform Management Bus (IPMB).

11. The method for obtaining the storage device state signal by using the BMC according to claim 9, wherein the storage device management program further comprises:
suspending at least one storage unit of the storage device according to the electric signal.

12. The method for obtaining the storage device state signal by using the BMC according to claim 1, wherein the storage device comprises a plurality of storage units, and the electric signal corresponds to the storage units.
